(19) United States
(12) Patent Application Publication
(10) Pub. No.: US 2026/0159150 A1
(43) Pub. Date: Jun. 11, 2026

(54) Steering Column Comprising a System for Both User Adjustment and for Absorbing Energy in the Event of an Accident

(71) Applicant: Robert Bosch GmbH, Stuttgart (DE)

(72) Inventors: Guillaume Briere, Lunay (FR); Benjamin Coudere, Vendome (FR); Eric Bouvier, Vendome (FR)

(21) Appl. No.: 19/150,101

(22) PCT Filed: Jan. 17, 2024
(86) PCT No.: PCT/EP2024/050990

§ 371 Date: Jul. 22, 2025

(30) Foreign Application Priority Data
Jan. 26, 2023 (FR) 2300751

(51) Int. Cl. B62D 1/19; B62D 1/184

(52) U.S. Cl. CPC B62D 1/192; B62D 1/184; B62D 1/195

(57) ABSTRACT

A steering column for a vehicle includes a sleeve for supporting a steering wheel, the sleeve being received in a bearing of a body and being longitudinally and angularly adjustable, and a clamping mechanism movable between positions for clamping and releasing the sleeve. The column further includes a rack rigidly connected to an energy-absorbing element, which is rigidly connected to both the body of the steering column and the sleeve, a locking member movable between positions for locking and unlocking the rack, and a locking control mechanism for controlling the locking member according to the position of the clamping mechanism.

### TECHNICAL FIELD OF THE INVENTION

The invention generally relates to the technical field of steering columns.

The invention relates more specifically to a steering column comprising a system for adjusting, preferably manually, the relative axial position between two elements in translation relative to each other, thereby enabling the adjustment of the depth position of a steering wheel in a vehicle, such as a motor vehicle.

### PRIOR ART

Most modern cars are equipped with a system for adjusting the depth and height of the steering wheel (longitudinal and angular adjustment). The depth is adjusted via a set of telescopic tubes built into the steering column. A clamping mechanism enables the position of the steering wheel to be adjusted in the unlocked (or released) position, and kept in the selected position in the locked (clamped) position.

In the event of a frontal impact with the vehicle, the telescopic tubes provide the displacement required to absorb the energy of the driver's impact with the airbag and steering wheel. A friction or distortion system generates the force that, combined with the movement, absorbs the energy from the impact.

There are already solutions for adjusting the depth and height of the steering wheel, while equipping the steering column of the corresponding vehicle with an absorption mechanism in the event of an accident. However, the existing solutions have a number of drawbacks.

For example, the position or the size of the entire absorption mechanism does not enable it to be easily incorporated into all steering column configurations or at least into many steering columns.

Moreover, when stress is applied to the tube axis before a clamping mechanism lever is opened, some systems can cause the axial adjustment of the steering column to jam due to the frictional forces applied under the stress.

These constraints are all the more important as manufacturers seek to reduce the overall size of the steering column, making it particularly complex to incorporate these features enabling adjustment and energy absorption in the event of an accident.

### DISCLOSURE OF THE INVENTION

The invention aims to remedy all or part of the drawbacks in the prior art by providing, in particular, a solution with improved compactness that guarantees good integrability with steering column architecture and that offers reliable adjustment systems.

To this end, according to a first aspect of the invention, a steering column for a vehicle is provided, comprising:
a body equipped with a bearing;
a sleeve for supporting a steering wheel, the sleeve being received in the bearing and being at least longitudinally adjustable relative to the body;
a clamping mechanism provided with an operating lever, a clamping pin and a clamping device supported by the clamping pin, the clamping pin pivoting with the operating lever between a clamping position in which the clamping device blocks
the longitudinal translation of the sleeve and a release position in which the sleeve is free to slide longitudinally relative to the body;
   the steering column being characterized in that it comprises:
an axial rack rigidly connected to an element for absorbing energy by distortion, the rack being rigidly connected to a first of two elements consisting of the body of the steering column and the sleeve, and the energy-absorbing element being rigidly connected to a second of the two elements consisting of the body of the steering column and the sleeve;
a locking member movable between a position for locking the rack in which the locking member penetrates at least one notch on the rack to block it translationally, and a position for releasing the rack in which the locking member is moved away from the rack;
a locking control mechanism for controlling the locking member according to the position of the clamping mechanism such that: in the position for releasing the clamping mechanism, the locking member is in the position for releasing the rack;
and in the position for clamping the clamping mechanism, the locking member is pushed towards the position for locking the rack.

According to one embodiment, the bearing is a deformable bearing such that the clamping position corresponds to a position in which the clamping device compresses the deformable bearing so as to block the sleeve.

According to one embodiment, the body is toggle-mounted on a vehicle body to enable angular adjustment of the steering column, and is provided with the bearing receiving the sleeve.

According to one embodiment, the clamping mechanism is configured such that, in the clamping position, the clamping device blocks the longitudinal translation of the sleeve relative to the body and the rotation of the body, and such that, in the release position, the sleeve is free to slide longitudinally and to pivot.

According to one embodiment, the clamping device comprises a mobile cam rigidly connected to one end of the operating lever and of the clamping pin, and a fixed cam freely engaged on the clamping pin, and extension members, such as ramps or ball-and-socket rods, forming spacer members for altering a spacing on the mobile cam relative to the fixed cam to pull on the clamping pin and clamp the clamping mechanism when the operating lever is pivoted to the clamping position.

According to one embodiment, the locking control mechanism is laterally positioned relative to the sleeve, on the same side as the clamping mechanism, preferably between the operating lever and the sleeve.

According to one embodiment, the locking control mechanism comprises a control pin translationally guided by the fixed cam and acted upon by an energy-storing means such as a locking control spring.

According to one embodiment, the locking member is mounted movably, preferably pivotably, around an axis of rotation, relative to a mount for the locking member.

According to one embodiment, the mount for the locking member has an axial abutment interface configured to axially abut the rack.

According to one embodiment, the steering column is configured such that the rack/locking member connection forms a cam/follower connection for guiding said locking member towards the released position during a relative movement of the rack relative to the locking member, in the position for releasing the rack.

According to one embodiment, the operating lever comprises a handle so it can be manually operated by a user.

### BRIEF DESCRIPTION OF THE FIGURES

Other features and advantages of the invention will become apparent from the following description, with reference to the appended figures, which illustrate:

FIG. 1: an isometric view of a steering column according to the invention;

FIG. 2: an exploded view of a steering column according to the invention;

FIG. 3: an isometric view of a detail of a locking control mechanism according to one embodiment, controlling a locking member according to the position of the clamping mechanism, shown in a first configuration in a driving situation;

FIG. 4: a cross-sectional view of the locking control mechanism according to the embodiment in FIG. 2, controlling the locking member according to the position of the clamping mechanism, shown in a second configuration in a driving situation;

FIG. 5: a cross-sectional close-up view of the locking member in FIG. 4;

FIG. 6: an isometric view of a detail of the locking control mechanism according to the embodiment in FIG. 2, controlling the locking member according to the position of the clamping mechanism, shown in a second configuration in a steering column adjustment situation;

FIG. 7: a view from underneath of a detail of the assembly of the locking member in FIG. 6;

FIG. 8: an isometric view of a detail of a locking control mechanism according to another embodiment, controlling a locking member according to the position of the clamping mechanism, shown in a driving situation;

FIG. 9: a side view of a detail in FIG. 8;

FIG. 10: an isometric view of a detail of a locking control mechanism according to another embodiment, controlling a locking member according to the position of the clamping mechanism, shown in a driving situation;

FIG. 11: a side view of a detail in FIG. 10;

FIG. 12: a side view of the engagement of the locking member in the rack in another embodiment;

FIG. 13: a diagram of a configuration in which a locking member is in the equilibrium position for locking the rack;

FIG. 14: a diagram of a configuration in which the locking member in FIG. 13A is in the position for releasing the rack held by a control pin on the locking control mechanism;

FIG. 15: a diagram of a configuration in which a locking member is in the equilibrium position for releasing the rack;

FIG. 16: a diagram of a configuration in which the locking member in FIG. 13A is in the position for locking the rack held by a control pin on the locking control mechanism;

FIG. 17: a diagram illustrating the lever arm effect between a control pin on the locking control mechanism and a locking member.

To ensure clarity, identical or similar elements are numbered identically throughout the figures.

### DETAILED DESCRIPTION OF AN EMBODIMENT

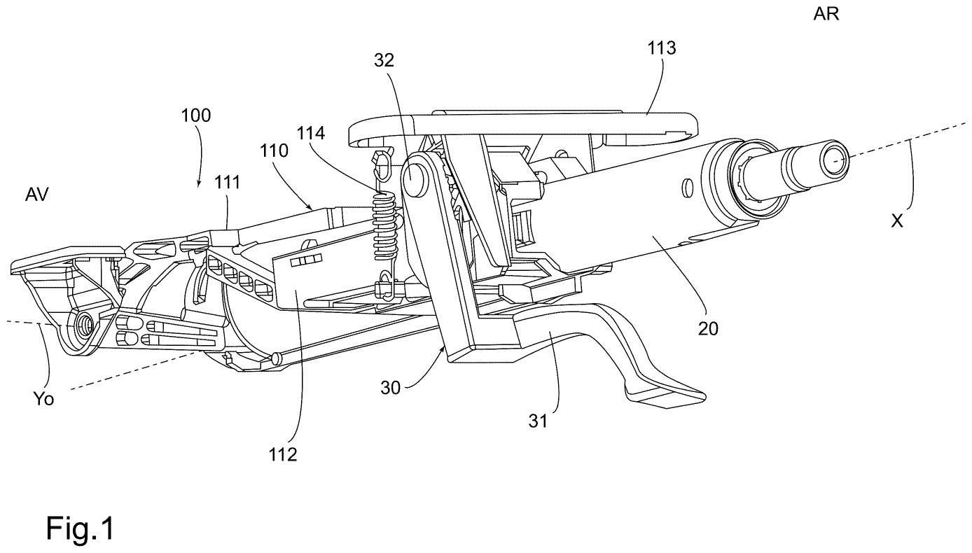

To describe the various figures, the orientation convention used will be that of the steering column 100 shown in FIG. 1, and the expressions “upstream” and “downstream” are associated with clockwise movement, which is also the direction in which an operating lever 31 is pivoted to release the lock on the steering column 100. The front AV/rear AR side is that of the steering column 100 installed in a vehicle.

FIG. 1 shows an isometric view of a steering column 100 according to the invention, comprising a mount 110 fastened to the vehicle body and supporting an adjustable sleeve 20 provided with a tube supporting the steering wheel (not shown). The tube is translationally connected to the sleeve 20 but is free to rotate. The sleeve 20 is locked/released for adjustment by a clamping mechanism 30. The steering column 100 can be adjusted in inclination and length relative to the vehicle body. The mount 110 consists of a front crossbar 111, connected by two sides 112 to a rear yoke 113. The crossbar 111 and the yoke 113 are fastened to the vehicle body so as to suspend the steering column 100 to adjust its inclination and length. A spring 114 on one or both sides secures the body 10, forming at least locally a cradle for the sleeve 20, to the mount 110 to support the adjustable sleeve 20 during the angular adjustment movement and the longitudinal adjustment movement. The sleeve 20 is supported by the body 10, which is toggle-mounted around a transverse pivot axis Y0 for angular adjustment of the steering column 100. At its other end, the body 10 is provided with a deformable bearing 11 receiving the sleeve 20 longitudinally adjustable relative to the body 10 while being rotationally locked. The deformable bearing 11 passes between two arms of the yoke 113 in the shape of an inverted “U”. The clamping device 30, associated both with the body 10 and with the mount 110 at its yoke 113 and its deformable bearing 13, simultaneously blocks the angular and longitudinal adjustment movements of the sleeve 20 and thus of the steering column 100. The bearing 11 is a deformable bearing such that the clamping position corresponds to a position in which the clamping device 33 compresses the deformable bearing 11 so as to block the sleeve 20.

The clamping mechanism 30 is aligned with the transverse axis Y, perpendicular but not coplanar to the longitudinal adjustment axis X of the steering column 100. Angular adjustment is done by toggling, around the axis Y0, the pivot connecting the steering column body 10 to the lateral flanges on the mount 110. The geometric Y axis of the clamping mechanism 30 is movable because it is rigidly connected to the body 10, in particular to the deformable bearing 11, which is rigidly connected to the body 10 via the yoke 113. In this way, the clamping mechanism 30 aligned on the geometric axis is configured such that, in the clamping position, the clamping device 33 blocks the longitudinal translation of the sleeve 20 relative to the body 10 and the rotation of the body 10, and such that, in the release position, the sleeve 20 is free to slide longitudinally and to pivot.

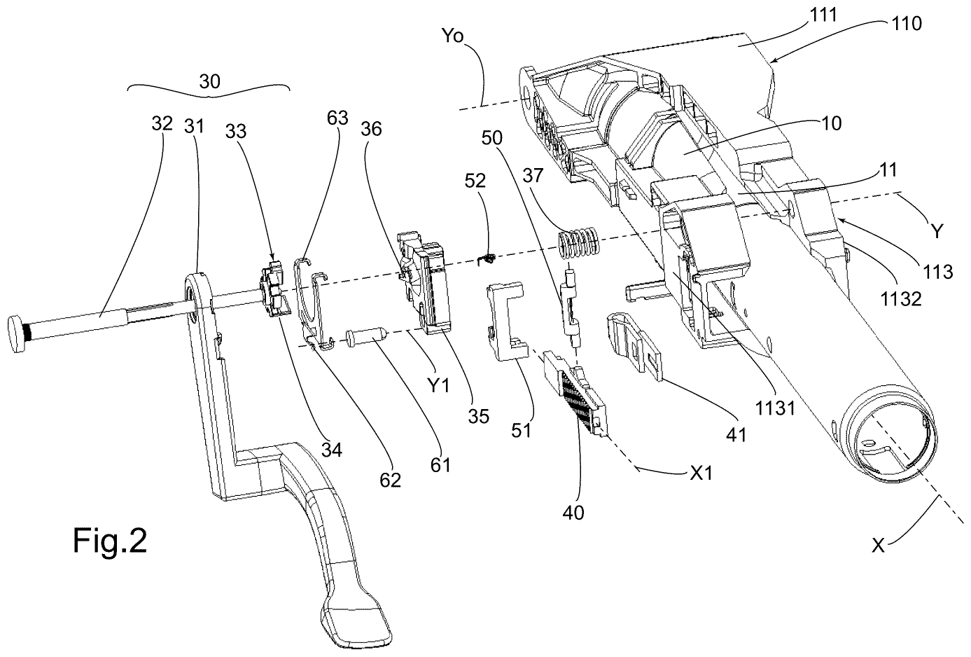

FIG. 2 illustrates an exploded view of the steering column 100 according to the invention, in which each element is visible. The clamping device 30 is controlled by the operating lever 31 between its clamping position and its release position for adjustment. The clamping mechanism 30 further comprises a clamping pin 32 extending transversely relative to the steering column 100, and a clamping device 33 supported by the clamping pin 32. In other words, the clamping pin 32 is supported on either side of the bearing 11 by the two arms of the yoke 113.

The operating lever 31 is rigidly connected to the clamping pin 32 at a proximal end of the operating lever 31 and extends to a distal end with a manual gripping interface so that it can be manually operated by a user in the motor vehicle.

The clamping pin 32 pivots with the operating lever 31 between:
the clamping position, in which the clamping device 33 blocks the longitudinal translation of the sleeve 20 at least for longitudinal adjustment, but preferably also blocks any pivoting for angular adjustment, and
the release position, in which the sleeve 20 is free to slide longitudinally relative to the body 10, or even pivot, due to the body 10 being free to pivot relative to its mount 110, to ensure angular adjustment.

To do so, the clamping device 33 comprises a mobile cam 34 rigidly connected to one end of the operating lever 31 and of the clamping pin 32, and a fixed cam 35 freely engaged on the clamping pin 32, and extension members 36 forming spacer members for altering a spacing on the mobile cam 34 relative to the fixed cam 35 to:
pull on the clamping pin 32 and clamp the clamping mechanism 30 when the operating lever 31 is pivoted to the clamping position, that is, by moving the mobile cam 34 away from the fixed cam 35; and inversely
releasing the clamping to release the clamping mechanism 30 when the operating lever 31 is pivoted to the release position; that is, moving the mobile cam 34 closer to the fixed cam 35.

The mobile cam 34, the fixed cam 35 and an energy storage means such as a spiral spring 37 are traversed by the clamping pin 32 passing in this example above the sleeve 20 after having traversed a first slide on one of the arms 1131 of the yoke 113 to then traverse a second slide on the other of the arms 1132 on the yoke 113 and receive, beyond the second arm 1132, a nut screwed onto the threaded end of the clamping pin 32 with the interposition of a needle stop and a washer (not shown). Alternatively, the steering column 100 can be configured so that the clamping pin 32 passes under the sleeve 20.

In this sequence of components, the mobile cam 34 presses against one side of the fixed cam 35, which in turn presses against the first arm 1131 of the yoke 113; the nut presses externally against its second arm 1132. The fixed cam 35 is rotationally fixed relative to the clamping pin 32, but translationally free both in the “vertical” direction of the first arm slide 1131 and along the clamping pin 32 (crosswise along the Y axis) such that the cam effect caused between the mobile cam 34 and the fixed cam 35 by the extension members 36, generates, due to the pivoting of the mobile cam 34 and the lever 31, the axial movement of the fixed cam 35 which, depending on the direction of the movement, compresses or releases the arms 1131, 1132, the deformable bearing 11 and the body 10 on the sleeve 20 relative to the yoke 113. The spring 37 is arranged, in particular interposed, between the first arm 1131 of the yoke 113 and the fixed cam 35 to ensure a resilient force by the fixed cam 35 against the mobile cam 34 despite the variation in mutual spacing.

A conventional steering column has impact energy absorption means designed to control the movement of the steering column as a result of the impact. In the case of the present invention, in which the steering column 100 is deformable, it comprises a retractable steering wheel shaft formed by the sleeve 20, which is housed in the body 10 of the steering column, forming a deformable tubular casing comprising an energy absorption mechanism. In the event of an impact, the steering column 100 is forced to deform, the impact energy being absorbed by this energy absorption mechanism.

According to the present invention, the steering column 100 comprises an axial rack 40 rigidly connected to an energy-absorbing element 41, this assembly being:
on one hand, rigidly connected to a first of two elements consisting of the body 10 of the steering column 100 and the sleeve 20, and
on the other hand, rigidly connected to a second of the two elements consisting of the body 10 of the steering column 100 and the sleeve 20.

In this way, a load path is successively created between the sleeve 20, the assembly formed by at least the axial rack 40 along an axis X1 parallel to the longitudinal axis X of the steering column 100 and the energy-absorbing element 41, then the body 10 of the steering column 100. In the event of an impact, the steering column 100 will deform such that the sleeve 20 translates into the body 10 of the steering column 100, and part of the impact will be absorbed by the energy-absorbing element 41 placed in the path of the impact forces.

However, this energy absorption mechanism must be compatible with the longitudinal and angular adjustment of the steering column.

To this end, and again according to the invention, the steering column 100 has a locking member 50 that is movable between
a position for locking the rack 40, in which the locking member 50 penetrates at least one notch 42 on the rack 40 to translationally block it; and
a position for releasing the rack 40, in which the locking member 50 is moved away from the rack 40;

The steering column 100 also has a locking control mechanism 60 for controlling the locking member 50 according to the position of the clamping mechanism 30 so that:
in the position for releasing the clamping mechanism 30, the locking member 50 is in the position for releasing the rack 40; and
in the position for clamping the clamping mechanism 30, the locking member 50 is pushed towards the position for locking the rack 40.

The locking control mechanism 60 comprises a control pin 61 translationally guided along an axis Y1 parallel to the clamping pin 32 on the clamping mechanism 30. This translational guidance is ensured by a sliding pivot connection between said control pin 61 and the fixed cam 35, the pin sliding axially along the axis Y1 in a cylindrical housing with a matching size supported by the fixed cam 35 and arranged coaxially to the axis Y1.

The control pin 61 is resiliently acted upon at a rear end by an energy storage means 62. This energy storage means 62 comprises a locking control spring in the form of a leaf spring rigidly connected to the fixed cam 35. In particular, the leaf spring 62 is rigidly connected to a mount 63 configured for clipping, that is, for fastening by resilient deformation, in particular by means of resiliently deformable tabs, to the fixed cam 35, on an outer side of the fixed cam 35 relative to the steering column 100, that is, on the side of the fixed cam 35 facing the mobile cam 34, in other words, facing the operating lever 31. As this activation spring 62 is rigidly connected to the fixed cam 35, the axial movement of the fixed cam 35 when the clamping lever 31 is rotated moves the spring 62 axially closer parallel to a clamping pin 32 axis Y on the rack 40 activation spring 62 when the clamping mechanism lever is in the clamping position, and axially away parallel to the clamping pin 32 axis Y on the rack 40 activation spring 62 when the clamping mechanism 30 is in the release position.

The locking control mechanism 60 is configured such that a second end forming a head on the control pin 61, which is axially opposite its rear end relative to its translational axis Y1, can come into contact and press against the locking member 50 to push it towards the position for locking the rack 40 in the position for clamping the rack 40 clamping mechanism 30, this pressure being provided by the activation spring 62, the pressure of which increases from the release position to the clamping position.

In this configuration, the clamping mechanism 30, the locking member 50 and the locking control mechanism 60 are located laterally to the sleeve 20 and the body 10 of the steering column, on the same side, meaning that they are located on the same side of the yoke 113, on the side of the first arm 1131 of the yoke 113.

The operation of the locking control 60 and of the locking member 50 will be better understood from the following figures.

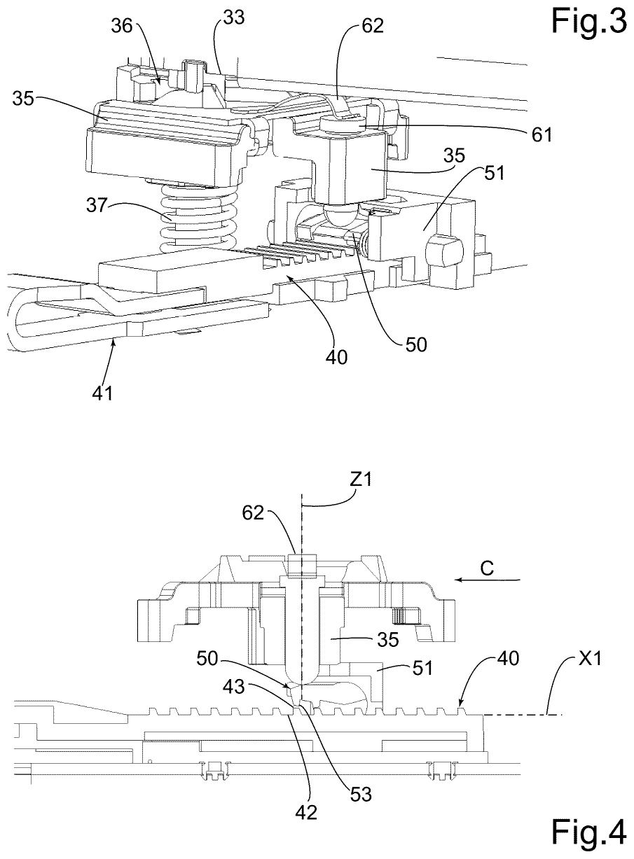

FIG. 3 is an isometric view of a detail of a locking control mechanism 60 according to this embodiment, controlling the locking member 50 according to the position of the clamping mechanism, shown in a first configuration in a driving situation.

FIG. 4 is a cross-sectional view of the locking control mechanism according to the embodiment in FIG. 2, controlling the locking member 50 according to the position of the clamping mechanism 30, shown in a second configuration in a driving situation.

With such a locking member 50 controlled by the locking control mechanism 60, the locking member 50 can be easily and reliably deactivated when the steering column 100 is in the adjustment position, such that when the clamping mechanism 30 is in the release position, the locking member 50 moves into a position for releasing the rack 40, meaning that the rack 40 is not engaged by the locking member 50.

On the other hand, in a driving situation, the longitudinal and angular adjustment of the steering column 100 is blocked, that is, in a position in which the clamping mechanism 30 is clamped, or in a position in which the clamping lever 31 is clamped. In such a position, the locking member 50 is acted upon by the locking control mechanism 60 to push said locking member 50 towards the position for locking the rack 40.

In this driving situation, two positions of the locking member 50 are possible:
a position in which at least one tooth 53 on the locking member 50 is engaged with the notches 42 on the rack 40 (see FIG. 3); the locking member 50 is kept engaged in the notches 42 on the axial rack via the control pin 61 guided by the fixed cam 35 and activated or pushed by the activation spring 62;
a position (shown in FIG. 4) in which no tooth 53 on the locking member 50 is engaged in the notches 42 on the rack 40 but the locking member 50 is kept on top of the teeth 43 on the axial rack 40 via the translationally guided control pin 61 by the fixed cam 35 and activated or pushed by the activation spring 62. In this state, the activation spring 62 has a higher pre-tension so that the locking member 50 can mesh with the notches 42 on the rack 40 when said rack 40 is translated, in particular by taking into account the axial rack 40 translation speed generated by an accident or a crash.

In a crash situation with an assembly according to the invention, two potential states are thus encountered:
a first state in which at least one tooth 53 on the locking member 50 is engaged in the axial rack 40, the sleeve 20 can slide into the body 10, actuating the energy-absorbing element 41;
a second state in which no tooth 53 on the locking member 50 is engaged in a notch 42 on the axial rack 40, with at least one tooth 53 on the locking member 50 contacting and pressing against a tooth 43 on the axial rack 40: the assembly formed by the sleeve 20 and the axial rack 40 slide until one of the at least one of the teeth 53 on the locking member 50 engages in a notch 42 on the axial rack 40 under the pressure of the activation spring 62.

FIG. 6 is a cross-sectional view of the locking control mechanism 60 according to the embodiment in FIG. 2, controlling the locking member 50 according to the position of the clamping mechanism 30, shown in a steering column adjustment situation 100.

When the clamping lever 31 is opened, the translation of the fixed cam 35 releases the pressure of the activation spring 62 on the control pin 61, which releases the pressure on the locking member 50. The locking member 50 is movably, in particular pivotally, mounted around an axis of rotation Z1, relative to a mount 51 of the locking member 50, this axis of rotation Z1 being orthogonal to an axis of translation X1 of the rack 40 and relative to the transverse axis Y. In this position for releasing the clamping lever 31, and therefore the clamping mechanism 30, the locking member 50 can be pivoted into the support 51 under the effect of a spring toggle 52 to release the teeth 43 of the axial rack 40 and thus enable axial adjustment of the steering column 100.

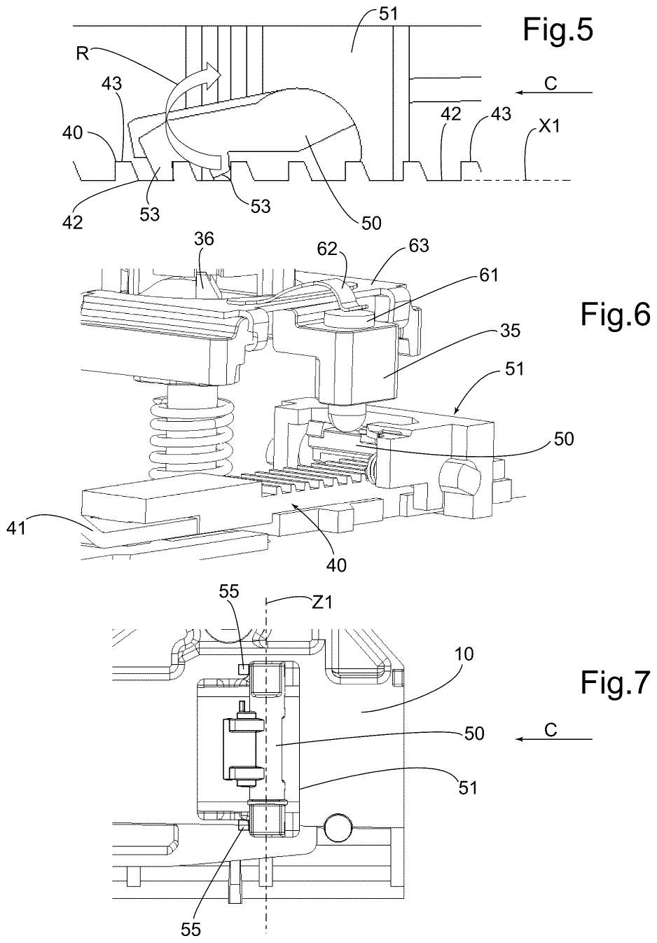

Usually, when opening the clamping lever 31, the user may apply pressure to the steering wheel, which could block the release of the teeth 53 on the locking member 50 in the notches 42 on the rack 40 and thereby disrupt the axial adjustment of the steering column 100. This disruption is caused by a longitudinal force applied to the steering wheel, which tends to apply a force from the rack 40 to the locking member 50, thereby increasing the friction and the locking force between these two elements 40, 50. With the operation of the locking control mechanism 60 and the locking member 50 according to the invention, the direct or clockwise rotation of the locking member 50 illustrated by an arrow R in FIG. 5 guarantees the release of the teeth 43 on the axial rack 40, and the axial adjustment of the steering column 100 will not be disrupted. This is all the more the case as the axis of rotation Z1 of the locking member 50 is located axially downstream of the tooth (or teeth) 53 on the locking member 50. Such a configuration implies a direction of rotation facilitating the release of the locking member 50 relative to the axial rack 40.

In other words, the rack 40 is configured to translate along a translation axis X1 contained in a translation plane, the axis of rotation Z1 of the locking member 50 being parallel to this translation plane, at least some of the notches 42 on the rack 40 and/or on the tooth (or teeth) 53 on the locking member 50 being configured to present at least one angled face relative to the translation plane so as to guide the movement of the locking member 50 towards a released position when the rack 40 is translated relative to the locking member 50 when a longitudinal force is applied to the steering wheel in at least one longitudinal direction during a steering column adjustment phase, that is, in the position for releasing the rack. Preferably, some of the notches 42 on the rack 40 and/or one or some of the teeth 53 on the locking member 50 have at least two separate faces that are angled relative to the translation plane such that:
some of these faces guide the movement of the locking member 50 towards a released position when the rack 40 and the locking member 50 are relatively translated in a first direction; and
other faces guide the movement of the locking member 50 towards a released position when the rack 40 and the locking member 50 are relatively translated in a second direction, axially opposite to the first direction; when a longitudinal force is applied to the steering wheel in either direction during a steering column adjustment phase, meaning in the position for releasing the rack.

Preferably, these faces are produced by bevelling all or part of the side walls of the tooth (or teeth) 53 and/or of the notches 42 to form these angled faces, at an angle in absolute value strictly less than 90°, preferably greater than 45°, relative to the translation plane.

In general, the steering column is configured such that the rack 40/locking member 50 connection forms a cam/follower connection to guide said locking member 50 towards the released position when the rack 40 moves relative to the locking member 50 during a steering column adjustment operation.

FIG. 7 is a view from underneath of a detail of the assembly of the locking member 50 in FIG. 6. In particular, in one embodiment, and to improve the crash load transfer between the axis of the locking member 50 and the mount 51, or even the body 10 of the steering column 100, one or more reinforcing elements 55 can be added in a suitable load transfer zone. An arrow C shown in FIG. 7 indicates the direction of force in the event of an accident or crash, with the user exerting force on the steering wheel from the rear to the front of the steering column. The reinforcing elements 55 are positioned between the locking member 50 and the mount 51, or even the body 10 of the steering column 100, in a configuration suitable for reinforcing the mount 51 and damping these crash forces C.

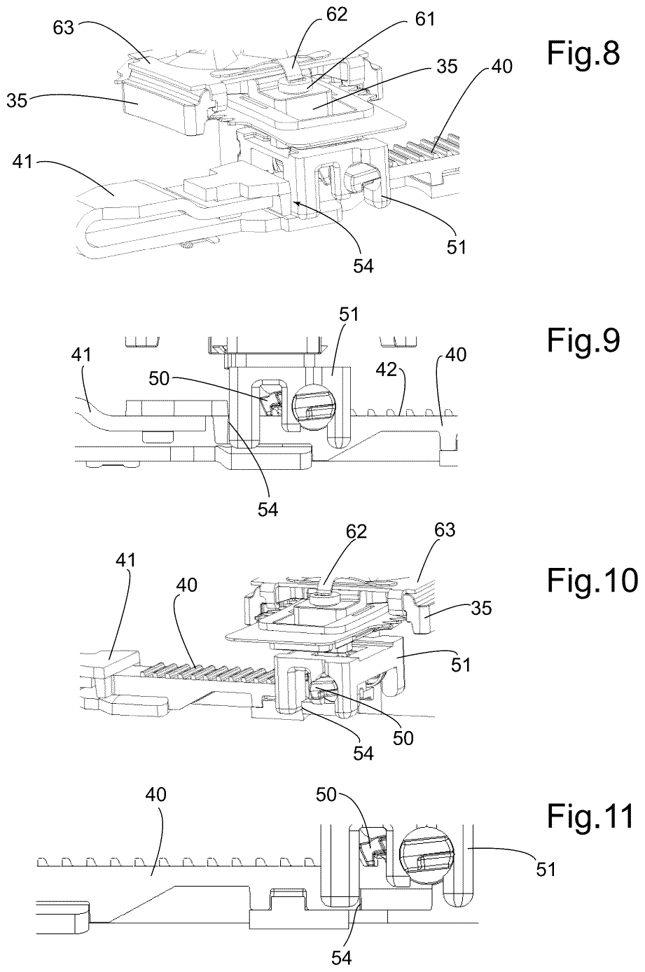

Of course, the mount 51 on the locking member 50 can be in various forms, and in particular be configured to provide an axial adjustment abutment. Thus, the mount 51 on the locking member 50 can have one or more abutment interface(s) 54 forming an adjustment abutment (see, for example, FIGS. 8, 9, 10 and 11). Such abutment interfaces make it possible to add an additional function to the adjustment mechanism 30, locking mechanism 50 and locking control mechanism 60, for even greater compactness. In particular, such a configuration ensures that, during adjustment, the sleeve 20 does not retract into the body 10 such that the locking member 50 might no longer be facing the rack 40.

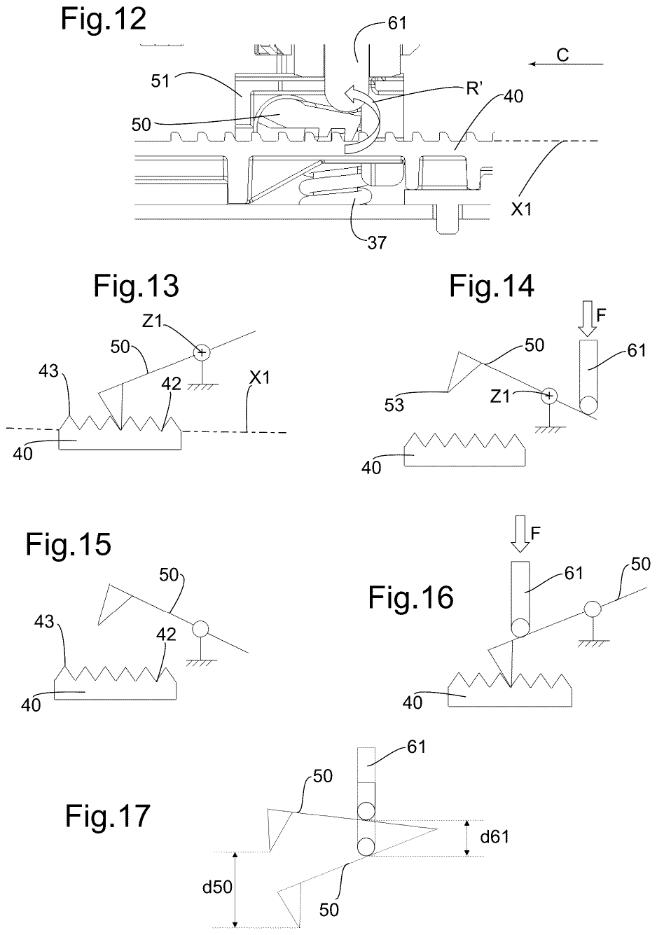

FIG. 12 shows a configuration that differs essentially from the embodiment in FIGS. 4, in that the pivoting direction R′ of the locking member 50 is reversed, in an indirect or counter-clockwise direction. In this configuration, the axis of rotation Z1 of the locking member 50 is axially positioned upstream of the tooth (or teeth) 53 on the locking member 50. Such a configuration implies a direction of rotation facilitating the release of the locking member 50 relative to the axial rack 40. Thus, the rack 40/locking member 50 connection also forms in this embodiment a cam/follower connection to guide said locking member 50 towards the released position when the rack 40 moves relative to the locking member 50 during a steering column adjustment operation. Such a configuration where the orientation of the locking member 50 is longitudinally reversed with its pivoting direction may be preferred, for example for reasons of available volume, while keeping a configuration that avoids disruption of steering column adjustment in the event of axial force.

As described, the locking control mechanism 60 is configured to control the locking member 50 according to the position of the clamping mechanism 30 so that: in the position for releasing the clamping mechanism 30, the locking member 50 is in the position for releasing the rack 40; and in the position for clamping the clamping mechanism 30, the locking member 50 is pushed towards the position for locking the rack 40.

These positions are originally set by simply rotating the clamping lever 31. In the embodiment described, the locking member 50 is kept engaged in the notches 42 between the teeth 43 on the axial rack 40 by the action of the locking control spring 62, and when the clamping lever 31 is opened, the release of the pressure exerted by the locking control spring 62 enables the spring toggle 52 to act on the control pin 61 to release the teeth 53 on the locking member 50 from the notches 42 on the axial rack 40.

Thus, according to this embodiment, the teeth 53 on the locking member 50 are naturally disengaged from the notches 42 on the axial rack 40 when the locking member 50 is not acted upon by the locking control mechanism 60.

FIGS. 13 and 14 show a diagram of a configuration in which the locking member 50 is in the equilibrium position for locking the rack; that is, a position naturally engaged in the notches 42 on the axial rack 40. Without any force being applied to the locking member 50 by the locking control mechanism 60, the teeth 53 on the locking member 50 are engaged in notches 42 on the axial rack 40 (see FIG. 13). The locking control mechanism 60 has to apply a force to the locking member 50 to release its teeth 53 from the notches 42 on the axial rack 40 (see FIG. 14), and thereby enable at least longitudinal adjustment of the steering column 100.

In comparison to FIGS. 13 and 14, FIGS. 15 and 16 show a diagram of a configuration in which the locking member 50 is in the equilibrium position for releasing the rack 40; that is, a position naturally disengaged from the notches 42 on the axial rack 40. Without any force being applied to the locking member 50 by the locking control mechanism 60, the teeth 53 on the locking member 50 are released from the notches 42 on the axial rack 40 (see FIG. 15), thereby enabling at least longitudinal adjustment of the steering column 100. The locking control mechanism 60 has to apply a force to the locking member 50, thereby pushing said locking member 50 via the control pin 61 on the locking control mechanism 60 in order to engage the teeth 53 on the locking member 50 in notches 42 on the axial rack 40 (see FIG. 16).

FIG. 17 schematically illustrates the lever arm effect of the force applied by the locking control mechanism 60 to the pivoting locking member 50. In particular, this force is applied by the control pin 61 on the locking control mechanism 60 to the locking member.

Depending on the geometry of the pivoting locking member 50, and the distance between the teeth 53 on the locking member 50 and its pivot axis Z1, the displacement d61 of the control pin 61 on the locking control mechanism 60 forming a cam can be chosen according to the displacement d50 of the teeth 53 on the locking member 50. Here, the steering column is configured so that the displacement d61 of the control pin 61 on the locking control mechanism 60 is less than or equal to, preferably strictly less than, the displacement d50 of the teeth 53 on the locking member 50.

Naturally, the invention is described in the foregoing by way of example. It is understood that the person skilled in the art will be able to arrive at various alternate embodiments of the invention without departing from the scope of the invention.

For example, the mount 51 for the locking member 50 can be omitted and its functions carried out directly by the steering column body 10, or even another part rigidly connected thereto, in particular an arm of the yoke 113.

The locking member 50, pivoting here so as to form a toggle, can also be replaced by one or more sleeves providing a similar coefficient of friction to the toggle-type locking member 50, as described.

Depending on the embodiment, it could also be foreseen that the control pin 61 on the control mechanism 60 is fixed relative to the fixed cam, or movable relative to the fixed cam.

The energy-absorbing element 41 can be different, for example by distortion and/or tearing.

It is emphasized that all of the characteristics, as they appear to a person skilled in the art from this description, from the drawings and from the attached claims, even though they have only been described in relation to other specific features, either separately or in any combination, can be combined with other characteristics or groups of characteristics disclosed herein, provided that this has not been expressly excluded or that technical circumstances do not render such combinations impossible or pointless.

1. A steering column for a vehicle comprising:
a body having a bearing;
a sleeve configured to support a steering wheel, the sleeve being received in the bearing and being at least longitudinally adjustable relative to the body
a clamping mechanism including an operating lever a clamping pin, and a clamping device supported by the clamping pin the clamping pin pivoting with the operating lever between a clamping position in which the clamping device blocks the longitudinal translation of the sleeve and a release position in which the sleeve is free to slide longitudinally relative to the body
an axial rack rigidly connected to an energy-absorbing element the axial rack being rigidly connected to a first one of the body of the steering column and the sleeve and the energy-absorbing element being rigidly connected to a second one of the body of the steering column and the sleeve;
a locking member movable between a first position for locking the rack in which the locking member penetrates at least one notch on the rack to block it the rack translationally, and a second position for releasing the rack in which the locking member is moved away from the rack
a locking control mechanism for controlling the locking member according to the position of the clamping mechanism such that:
in the release position of the clamping mechanism the locking member is in the second position for releasing the rack and
in the clamping position of the clamping mechanism the locking member is pushed towards the first position for locking the rack.

2. The steering column according to claim 1, wherein the bearing is a deformable bearing configured such that, in the clamping position, the clamping device compresses the deformable bearing so as to block the sleeve.

3. The steering column according to claim 1, wherein the body is toggle-mounted on a vehicle body to enable angular adjustment of the steering column and is provided with the bearing receiving the sleeve.

4. The steering column according to claim 1, wherein the clamping mechanism is configured such that, in the clamping position, the clamping device blocks the longitudinal translation of the sleeve relative to the body and the rotation of the body and such that, in the release position, the sleeve is free to slide longitudinally and to pivot.

5. The steering column according to claim 1, wherein the clamping device comprises:
a mobile cam rigidly connected to one end of the operating lever and of the clamping pin;
a fixed cam freely engaged on the clamping pin; and
extension members forming spacer members for altering a spacing on the mobile cam relative to the fixed cam to pull on the clamping pin and clamp the clamping mechanism when the operating lever is pivoted to the clamping position.

6. The steering column according to claim 1, wherein the locking control mechanism is laterally positioned relative to the sleeve on the same side as the clamping mechanism.

7. The steering column according to claim 5, wherein the locking control mechanism comprises a translationally guided control pin and is acted upon by an energy-storing mechanism.

8. The steering column according to claim 1, wherein the locking member is mounted movably, preferably pivotably, around an axis of rotation, relative to a mount for the locking member.

9. The steering column according to claim 8, wherein the mount for the locking member has an axial abutment interface configured to axially abut the rack.

10. The steering column according to claim 1, wherein a connection between the rack and the locking member forms a cam/follower connection configured to guide said locking member towards a released position during a relative movement of the rack relative to the locking member in the second position for releasing the rack.

11. The steering column according to claim 1, wherein the operating lever comprises a handle to enable the operating lever to be manually operated by a user.

12. The steering column according to claim 5, wherein the extension members include ramps or ball-and-socket rods.

13. The steering column according to claim 6, wherein the locking control mechanism is laterally positioned between the operating lever and the sleeve.

14. The steering column according to claim 7, wherein:
the locking control mechanism is guided by the fixed cam, and
the energy-storing mechanism is a locking control spring.

15. The steering column according to claim 8, wherein the locking member is mounted pivotably around the axis of rotation.
